(19) United States
(12) Patent Application Publication
(10) Pub. No.: US 2008/0116596 A1
(43) Pub. Date: May 22, 2008

(54) Method And Apparatus For Producing Plastic Optical Fiber

(75) Inventors: Tadahiro Kegasawa, Shizuoka (JP); Yasuhiro Koike, Kanagawa (JP)

Correspondence Address: SUGHRUE MION, PLLC, 2100 PENNSYLVANIA AVENUE, N.W., SUITE 800, WASHINGTON, DC, 20037, US

(73) Assignees: Yasuhiro Koike, Yokohama-shi (JP); FUJIFILM Corporation, Tokyo (JP)

(21) Appl. No.: 11/792,670

(22) PCT Filed: Jan. 24, 2006
(86) PCT No.: PCT/JP06/01392

§ 371 Date: Jun. 8, 2007

(30) Foreign Application Priority Data
Jan. 26, 2005 (JP) 2005-018098

(51) Int. Cl. B29D 11/00

(52) U.S. Cl. 264/1.29; 425/224

(57) ABSTRACT

A producing apparatus for producing a plastic optical fiber (11), in which a refractive index is distributed in a direction toward a center of a diameter (D1, D2), is provided. A first collection block (58) causes first and second molten resins (22, 23, 84, 85) together to flow to form a first multi layer fluid resin (22, 23) in a concentric fiber shape. A second collection block (59, 60) causes a third molten resin (21, 24) to flow together with the first multi layer fluid resin to form a second multi layer fluid resin (21-24) in a concentric fiber shape, so as to produce the plastic optical fiber from at least three resins. Also, the three resins contain a dopant at densities different from one another. Furthermore, a first diffusion tube (61) diffuses the dopant in the first multi layer fluid resin. A second diffusion tube (62, 63) diffuses the dopant in the second multi layer fluid resin.

### TECHNICAL FIELD

The present invention relates to a method and apparatus for producing plastic optical fiber. More particularly, the present invention relates to a method and apparatus for producing plastic optical fiber with high efficiency and also with high optical quality by preventing degradation of polymers.

### BACKGROUND ART

A plastic optical fiber (POF) is constructed of a core whose main component is organic compounds or polymers in a matrix, and a cladding composed of organic materials having a different refractive index from the core. Among various types of optical fibers, the plastic optical fiber has been publicly noted owing to large flexibility, small weight, high resistance to shock, and easy handling and production. The optical fiber has large diameter, and the low production cost, and also characteristically has a small transmission loss, a high transmission capacity, and high speed in the transmission

A graded index plastic optical fiber (GI-POF) is a plastic optical fiber with high performance, and has a core in which a refractive index is determined according to a suitable distribution. The refractive index increases in a direction from the periphery toward the axis of its core consecutively. As the refractive index is consecutively graded, it is possible to refract light gradually to travel exclusively within the core. Also, the inverse proportion of the speed of the light within a medium to the refractive index is utilized. As the speed of the light is set higher according to a distance from the axial position, time of reach of obliquely traveling light between one end and a second end of the plastic optical fiber can be set the same as time of reach of straight traveling light between the same. A waveform of the transmission can be stabilized.

There are plural suggestions of methods of producing the plastic optical fiber (POF) of the GI or other types. According to U.S. Pat. No. 6,254,808 (corresponding to JP-A 2000-356716), dopants or compounds for adjusting the refractive index in order to distribute plural values of the refractive index are contained in layers. A multi layer structure of resins is created by flowing the molten resins in a coaxial form. A diffuser heats and passes the molten resins to diffuse the dopants, to produce the plastic optical fiber continuously. U.S. Pub. No. 2002/0041042 (corresponding to JP-A 2003-531394) discloses a coextrusion die for extruding molten resins for layers, before those are heated at a temperature that is equal to or lower than a glass transition temperature Tg of an outermost one of the layers. Dopants contained in inner layers inside the outermost layer are thermally diffused, to obtained the distribution of the refractive index.

U.S. Pat. No. 5,593,621 (corresponding to JP-B 6-506106) discloses production of the plastic optical fiber (POF) by multiple flow of polymers with diffusability in the coaxial form, and by diffusing dopants within predetermined time. JP-A 8-334635 discloses production of the plastic optical fiber by use of two or more polymers containing non-polymerization compounds, and by extrusion in a die coaxially with a disposition of polymers with higher viscosity at the center than the periphery.

For the production by the consecutive extrusion of the plastic optical fiber (POF), additives such as dopants are diffused while molten polymers are flowing. If the polymers flow for a long time at high temperature, it is likely that there occur decomposition, degradation or unwanted coloring in the polymers. Optical quality may drop, for example regarding attenuation in the transmission. In U.S. Pat. No. 6,254,808 (corresponding to JP-A 2000-356716), a length of the diffuser for diffusing dopants requires 33 cm or more, and enlarges a size of the entire apparatus. This causes a problem in difficulty in the installation or rise in the manufacturing cost. Residence time of the polymers in the diffuser is considerably long to degrade the polymers.

U.S. Pub. No. 2002/0041042 (corresponding to JP-A 2003-531394) describes the conditioned temperature at each time after extruding one of the layers, but does not refer to a size or other specifics of the diffuser. In U.S. Pat. No. 5,593,621 (corresponding to JP-B 6-506106) or JP-A 8-334635, there is no suggestion of specific construction of the diffuser, or methods or conditions of the diffusion. Techniques of optimizing the plastic optical fiber (POF) according to multi extrusion have not been suggested.

In view of the foregoing problems, an object of the present invention is to provide a method and apparatus for producing plastic optical fiber with high efficiency and also with high optical quality by preventing degradation of polymers.

### DISCLOSURE OF INVENTION

In order to achieve the above and other objects and advantages of this invention, a producing method of producing a plastic optical fiber, in which a refractive index is distributed in a direction toward a center of a diameter, is provided. In a first collecting/diffusing step, first and second molten resins are caused together to flow to form a first multi layer fluid resin in a concentric fiber shape, and a dopant in the first multi layer fluid resin is diffused by a first diffuser, the first and second resins containing the dopant at densities different from one another In at least one second collecting/diffusing step, a third molten resin is caused to flow together with the first multi layer fluid resin to form a second multi layer fluid resin in a concentric fiber shape, and the dopant in the second multi layer fluid resin is diffused by a second diffuser, the second and third resins containing the dopant at densities different from one another, whereby the plastic optical fiber is produced from at least the first, second and third resins.

Furthermore, there is an extruding step of extruding the second multi layer fluid resin to produce an optical fiber preform. In a drawing step, the optical fiber preform is thermally drawn, to form the plastic optical fiber.

In the first collecting/diffusing step, the second resin being molten is distributed to flow in a ring shape, together to flow the first and second resins by delivering the second resin about the first resin while the first resin being molten flows in a rod shape. In the second collecting/diffusing step, the third resin being molten is distributed to flow in a ring shape, together to flow the first multi layer fluid resin and the third resin by delivering the third resin about the first multi layer fluid resin.

Furthermore, there is a cooling step of cooling the optical fiber preform from the extruding step, wherein the drawing step is provided with the optical fiber preform by the cooling step.

The first and second diffusers have a size L in a direction of a flow of the first or second multi layer fluid resin, and the size L is equal to or more than 30 mm and equal to or less than 330 mm.

The at least one second collecting/diffusing step is at least two second collecting/diffusing steps.

The densities of the dopant in the first, second and third resins are higher according to closeness of the first, second and third resins to the center.

The first, second and third resins contain a polymer created from a (meth)acrylate ester.

In one aspect of the invention, a producing apparatus for producing a plastic optical fiber, in which a refractive index is distributed in a direction toward a center of a diameter, is provided. A first collector causes first and second molten resins together to flow to form a first multi layer fluid resin in a concentric fiber shape. At least one second collector causes a third molten resin to flow together with the first multi layer fluid resin to form a second multi layer fluid resin in a concentric fiber shape, so as to produce the plastic optical fiber from at least the first, second and third resins.

Furthermore, a first distributor distributes the second resin being molten to flow in a ring shape, together to flow the first and second resins by delivering the second resin about the first resin being molten supplied in the first collector. At least one second distributor distributes the third resin being molten to flow in a ring shape, together to flow the first multi layer fluid resin and the third resin by delivering the third resin about the first multi layer fluid resin being molten supplied in the at least one second collector.

The first, second and third resins contain a dopant at densities different from one another. Furthermore, a first diffuser diffuses the dopant in the first multi layer fluid resin. A second diffuser diffuses the dopant in the second multi layer fluid resin.

The at least one second collector is at least two second collectors consecutive with one another.

Furthermore, an extruding die extrudes the second multi layer fluid resin to produce an optical fiber preform. A drawing device thermally draws the optical fiber preform, to form the plastic optical fiber.

Consequently, it is possible according to the invention to produce plastic optical fiber with high efficiency and also with high optical quality by preventing degradation of polymers, owing to the construction of the two or more collecting/diffusing steps for overlaying the three or more layers of resins.

### BRIEF DESCRIPTION OF DRAWINGS

FIG. 1 is a flow chart illustrating a plastic optical fiber (POF) producing system;

FIG. 2 is a cross section illustrating a plastic optical fiber (POF);

FIG. 3 is an explanatory view in graph, illustrating a distribution of a refractive index;

FIG. 4 is an explanatory view in a block diagram, schematically illustrating the plastic optical fiber (POF) producing system, particularly with a co-extruder.

### BEST MODE FOR CARRYING OUT THE INVENTION

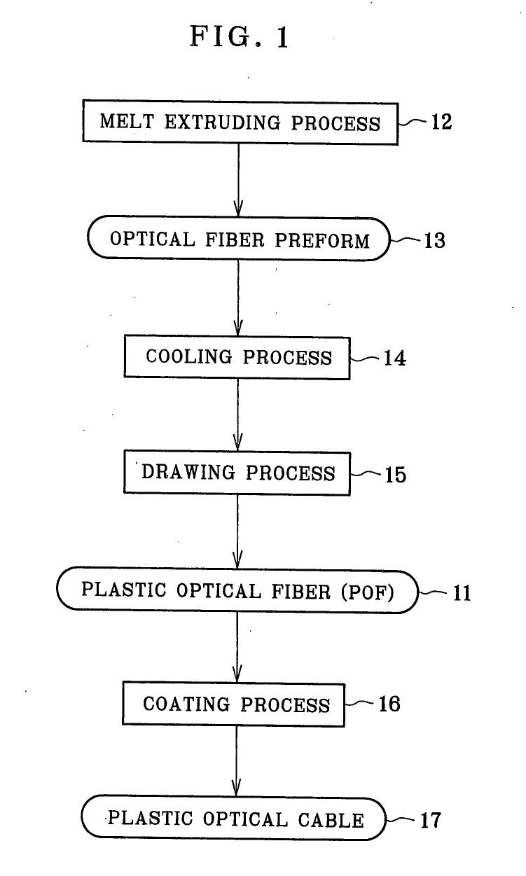

Preferred embodiments are described by referring to the drawings. The invention is not limited to those embodiments. In FIG. 1, a flow of production of the plastic optical fiber (POF) is illustrated. At first, basic construction with the processes in the production is described.

A plastic optical fiber (POF) producing system of the invention includes a melt extruding process 12, a cooling process 14, a drawing process 15, and a coating process 16. The melt extruding process 12 is supplied with and melts a plurality of polymers, and forms an optical fiber preform namely optical fiber raw wire 13 of a multi layer structure by extrusion, the optical fiber preform 13 being a principal part of a plastic optical fiber (POF) 11. The cooling process 14 is next to the melt extruding process 12, and cools the optical fiber preform 13. The drawing process 15 is next to the cooling process 14, and stretches and draws the optical fiber preform 13 with heat to form the plastic optical fiber 11 at a predetermined diameter. The coating process 16 overlays the outside of the plastic optical fiber 11 with a sheath material as a protective layer, to obtain a plastic optical cable 17.

The plastic optical fiber (POF) 11 passed through the coating process 16 is referred to as a plastic optical fiber cable or plastic optical fiber cord. Note that a term of a single fiber cable is used for such having single optical fiber cord and a coating applied thereabout as desired. A term of a multi fiber cable is used for such including plural optical fiber cords, a tension element for combining those, and a coating applied thereabout. The plastic optical cable 17 in the present specification means any one of the single fiber cable and the multi fiber cable.

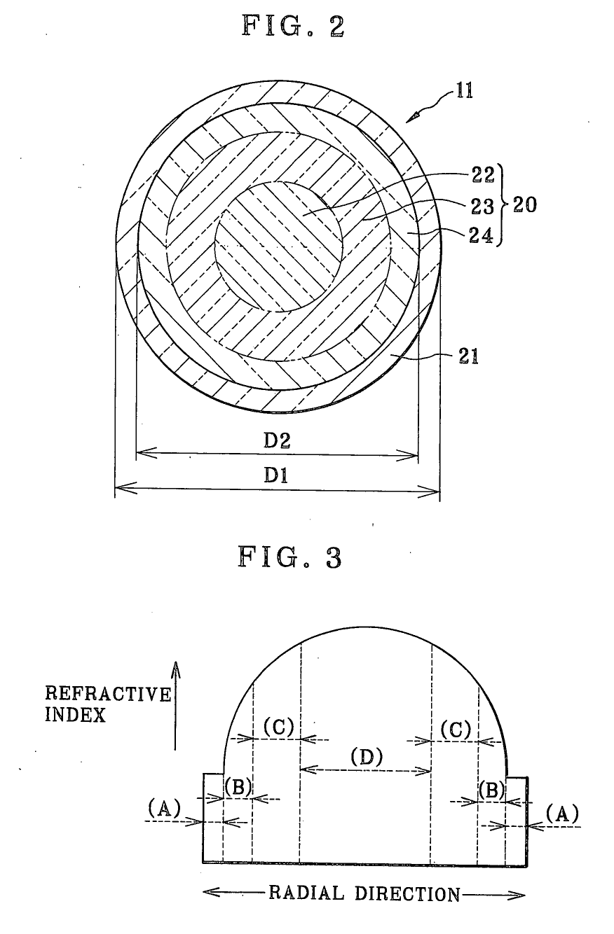

In FIG. 2, the plastic optical fiber (POF) 11 is illustrated in a cross section. The plastic optical fiber 11 includes a core group or composite core 20, and an outer cladding 21. The composite core 20 is adapted to transmission of light. The outer cladding 21 is disposed about the composite core 20. The outer cladding 21 has a pipe shape of which an outer diameter D1 and an inner diameter D2 are constant in the longitudinal direction, and which has a regular thickness. The outer cladding 21 has a different refractive index from that of the composite core 20. The composite core 20 includes a first core 22, a second core 23 and an inner cladding 24. The first core 22 is axial. The second core 23 is overlaid on the outside of the first core 22. The inner cladding 24 is overlaid on the outside of the second core 23, and positioned inside the outer cladding 21. Of course, an inner diameter of the outer cladding 21 is equal to an outer diameter of the inner cladding 24. Similarly, an interface between the first and second cores 22 and 23 has a constant diameter. An interface between the second core 23 and the inner cladding 24 has a constant diameter.

In FIG. 3, a distribution of a refractive index of the plastic optical fiber (POF) 11 is illustrated. In FIG. 3, a reference sign A indicates a range of the refractive index of the outer cladding 21 in FIG. 2. A reference sign B indicates a range of the refractive index of the inner cladding 24 in FIG. 1. A reference sign C indicates a range of the refractive index of the second core 23. A reference sign D indicates a range of the refractive index of the first core 22.

In FIG. 3, the composite core 20 has a distribution of a refractive index which increases gradually from the outer cladding 21 toward the fiber center. The composite core 20 has a higher refractive index than the outer cladding 21. In the composite core 20, the first core 22 has the highest refractive index. The second core 23 has a medium refractive index. The inner cladding 24 has the lowest refractive index. It is preferable that a difference between the maximum refractive index and the minimum refractive index is equal to or higher than 0.001 and equal to or lower than 0.3 in the radial direction of the circle as viewed in section. Thus, the plastic optical fiber 11 has an optical characteristic of a fiber of the GI type. Note that the optical fiber preform 13 of FIG. 1 has a greater diameter than the plastic optical fiber 11 in the state prior to the drawing, but is structurally the same as the plastic optical fiber 11. In FIG. 2, interfaces between the cores are clearly depicted, but may be not clear in consideration of visual recognition, because clearness of the interfaces differs according to conditions of the manufacture.

An optical fiber of the invention may have a structure different from the three layer structure of the first and second cores 22 and 23 and the inner cladding 24 in the composite core 20. One example of the composite core 20 is one which has a refractive index increasing from the outer cladding 21 to the center of the composite core 20 in a continuous or stepwise manner without interfaces or borderlines. A second example or the composite core 20 is a multi layer structure. In the present embodiment, two or more claddings 21 and 24 are formed as a multiple cladding. However, the outer cladding 21 may be single. The plastic optical fiber 11 may be so constructed that light may reflected by an interface between the outer and inner claddings 21 and 24 to pass all of the composite core 20. Otherwise, the plastic optical fiber 11 may be so constructed that light may pass only the first core 22. A type of the plastic optical fiber 11 may be any one of a single mode, a multi mode, the SI type and the GI type. However, the plastic optical fiber 11 can be the GI type specifically to have a higher performance of optical transmission than the SI type.

Preferable materials for the composite core 20 and the outer cladding 21 in the plastic optical fiber (POF) 11 can be thermoplastic organic materials having high optical transmittance. A preferable composition of an organic material can contain a (meth)acrylate ester as a main content. Specific examples of such will be described later in detail. Note that a material having a refractive index lower than that for the composite core 20 can be used for the outer cladding 21. A preferable material for the composite core 20 can be a fluorine-containing resin, which is effective in facilitating the production in compliance with a low refractive index at high quality.

The outer cladding 21 is formed from such a polymer having a lower refractive index than the composite core 20 as to reflect light on an interface between the composite core 20 and the outer cladding 21 in transmission through the composite core 20. The composite core 20 and the outer cladding 21 can be preferably formed from amorphous polymers for preventing dispersion of light, and can have suitability for adhesion, high toughness among various characteristic items, and high resistance to humidity. Also, the material for the outer cladding 21 can preferably have low water absorption because entry of moist into the composite core 20 should be prevented. A preferred polymer for the outer cladding 21 has a water absorption of saturation lower than 1.8%. A further preferred polymer for the inner cladding 24 has a water absorption of saturation lower than 1.5%, and desirably lower than 1.0%. Note that the water absorption of saturation is measured by the ASTM, D570, namely by dipping a sample in water at 23 deg. C. for one week. In addition, substances for the composite core 20 and/or the outer cladding 21 can include a fluorine resin. Various polymers used for the composite core 20 and the outer cladding 21 will be described below.

Preferable materials for forming the composite core 20 include:

A. Non-fluorine (meth)acrylate esters

B. Fluorine-containing (meth)acrylate esters

C. Styrene compounds

D. Vinyl esters

E. Polymerizable monomers for obtaining

fluorine-containing polymers with a cyclic main chain, and polymer obtained from bis phenol A as a polymerizable monomers for obtaining polycarbonates.

To form a cladding, polyvinylidene fluoride (PVDF) is also preferable as a polymer. Other examples include homopolymers obtained by polymerizing those, copolymers obtained polymerizing two or more of those, and blends of at least one of the homopolymers and at least one of the copolymers. If a raw material is a blend, the boiling point Tb is defined as the lowest of the temperatures of plural initial compounds contained in the mixture, or as a lowered boiling point in case a drop of the boiling temperature occurs owing to the effect of an azeotropic mixture. If a raw material is a copolymer or blend polymer obtained from mixed substances, the glass transition temperature Tg is defined according to that of the copolymer or blend polymer. Preferable examples of copolymers or blend polymers are such containing (meth)acrylate esters or fluorine-containing polymers for the purpose of optical transmitting elements. Details of those examples will be described below.

Examples of non-fluorine acrylate esters and non-fluorine methacrylate esters (A) include: methyl methacrylate, ethyl methacrylate, isopropyl methacrylate, tert-butyl methacrylate, benzyl methacrylate, phenyl methacrylate, cyclohexyl methacrylate, diphenyl methyl methacrylate, tricyclo [5.2.1.0.sup.2,6] decanyl methacrylate, adamantyl methacrylate, isobornyl methacrylate, norbornyl methacrylate, methyl acrylate, ethyl acrylate, tert-butyl acrylate, and phenyl acrylate.

Examples of fluorine-containing acrylate esters and fluorine-containing methacrylate esters (B) include: 2,2,2-trifluoro ethyl methacrylate, 2,2,3,3-tetrafluoro propyl methacrylate, 2,2,3,3,3-pentafluoro propyl methacrylate, 1-trifluoro methyl-2,2,2-trifluoro ethyl methacrylate, 2,2,3,3,4,4,5,5-octafluoro pentyl methacrylate, and 2,2,3,3,4,4-hexafluoro butyl methacrylate.

Examples of styrene compounds (C) include: styrene, alpha-methyl styrene, chloro styrene, and bromo styrene. Examples of vinyl esters (D) include: vinyl acetate, vinyl benzoate, vinyl phenyl acetate, and vinyl chloro acetate. Examples of polymerizable monomers for obtaining cyclic fluorine-containing polymers with a main chain cyclic group (E) include monomers which have a cyclic structure, or which is polymerizable in a ring polymerization to produce fluorine-containing polymers having a ring structure on an amorphous main chain. Specifically, such examples include poly perfluoro butanyl vinyl ether, and monomers suggested in JP-A 8-334634 to produce polymers having an aliphatic ring or heterocyclic ring on a main chain. The invention is not limited to those polymers. Substances and a ratio of the composition are preferably determined so that a refractive index of a homopolymer or copolymer can be in a predetermined refraction distribution in a multi layer fluid resin when formed as an optical transmitting element.

Further examples of polymers for the outer cladding 21 in addition to the above are as follows.

Copolymers produced from methyl methacrylate (MMA) and a fluorinated (meth)acrylate, for example, one of trifluoro ethyl methacrylate (FMA), hexafluoro isopropyl methacrylate, and the like.

Copolymer produced from methyl methacrylate (MMA) and a tert-butyl methacrylate or other (meth)acrylate having a branch, and copolymers produced from methyl methacrylate (MMA) and a cyclic (meth)acrylate, for example, isobornyl methacrylate, norbornyl methacrylate, and tricyclo decanyl methacrylate.

Also, polycarbonates (PC), norbornene resins, such as Zeonex (trade name) manufactured by Zeon Corporation, functional norbornene resins, such as Arton (trade name) manufactured by JSR Corporation, fluorine resins, such as polytetra fluoro ethylene (PTFE), and polyvinylidene fluoride (PVDF).

Copolymers of fluorine resins, for example PVDF copolymers, such as tetrafluoro ethylene perfluoro (alkyl vinyl ether) (PFA) random copolymers, and chloro trifluoro ethylene (CTFE) copolymers.

It is to be noted in such polymers that hydrogen (H) atom can be preferably substituted for heavy hydrogen (D) atom. This being so, the transmittance of the produced optical fiber in the large wavelength range can be made higher, by reducing loss in the transmittance, in particular in an infrared region of the wavelength.

When the plastic optical fiber (POF) 11 is used for near infrared ray, the C—H bonds in the plastic optical fiber 11 cause the absorption loss. Accordingly, polymers obtained by substitution according to U.S. Pat. No. 5,541,247 (corresponding to JP-B 3332922) and JP-A 2003-192708 can be used, in which the hydrogen atom in the C—H bond is substituted by the heavy hydrogen (deuterium) or fluorine in the polymer, and the core is formed from the polymers after the substitution treatment. Thus, the wavelength range of the transmitting light, in which the transmission loss occurs, can be shifted in the large wavelength area. Thus the loss of the transmitting light is reduced. Examples of such polymers include deuteriated polymethyl methacrylate (PMMA-d8), polytrifluoroethyl methacrylate (P3FMA), polyhexafluoro isopropyl-2-fluoroacrylate (HFIP2-FA) and the like. Note that when the polymer to be used for the optical fiber is prepared from the monomers, it is preferable to remove the impurities and foreign materials before polymerization such that the transparency will be ensured at least the predetermined grade after the polymerization.

Further, it is preferable that the average molecular weight of polymers for the composite core 20 and the outer cladding 21 is determined also in view of the smooth drawing. The average molecular weight is preferably in a range between 10,000 and 1,000,000, and especially between 30,000 and 500,000. Furthermore, the molecular weight distribution (MWD=average molecular weight/numeral molecular weight) influences on the drawing. Even when the small amount of the polymers of extremely large molecular weight is contained, the drawing becomes less smooth, or becomes impossible. Thus, the MWD is preferably 4 or less, and especially 3 or less.

Polymerization initiators can be used for reaction of polymerizable compounds to produce polymers. Some examples of polymerization initiators create a radical. Those include peroxide compounds and azo compounds.

Peroxide compounds: benzoyl peroxide (BPO), tert-butyl peroxy-2-ethyl hexanoate (PBO), di-tert-butyl peroxide (PBD), tert-butyl peroxy isopropyl carbonate (PBI), and n-butyl-4,4-bis(tert-butyl peroxy) valerate (PHV).

Azo compounds:

2,2′-azobis isobutyro nitrile, 2,2′-azobis(2-methyl butyro nitrile), 1,1′-azobis(cyclohexane-1-carbo nitrile), 2,2′-azobis(2-methyl propane), 2,2′-azobis(2-methyl butane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethyl butane), and 2,2′-azobis(2,4,4-trimethyl pentane);

3,3′-azobis(3-methyl pentane), 3,3′-azobis(3-methyl hexane), 3,3′-azobis(3,4-dimethylpentane), 3,3′-azobis(3-ethyl pentane), dimethyl-2,2′-azobis(2-methyl propionate), diethyl-2,2′-azobis(2-methyl propionate), and di-tert-butyl-2,2′-azobis(2-methyl propionate).

Two or more of the above initiators and other substances may be used in combination.

To set the mechanical property of mechanisms suitably in a predetermined range for drawing to produce the optical fiber, a polymerization degree of the polymer can be controlled. Polymerizable monomers as compounds can contain chain transfer agents which are mainly used for controlling polymerization degree. Compounds and amounts of the chain transfer agents are selected in accordance with which polymerizable monomers are used. Examples of chain transfer coefficients of the chain coefficient agent to the respective monomers are described in “Polymer Handbook, 3rd edition”, (edited by J. BRANDRUP & E. H. IMMERGUT, issued by JOHN WILEY & SONS). In addition, chain transfer coefficients may be calculated by means of conducting experiments in the method described in ‘Kobunshi Gosei No Jikkenho’ (Experimental Method for Polymer Synthesis) by Takayuki Otsu and Masayoshi Kinoshita, issued by Kagaku-Dojin Publishing Company, Inc., 1972).

Examples of chain transfer agents include alkylmercaptans, such as n-butylmercaptan, n-pentylmercaptan, n-octylmercaptan, n-laurylmercaptan, tert-dodecylmercaptan, and the like, and thiophenols, such as thiophenol, m-bromothiophenol, p-bromothiophenol, m-toluenethiol, and p-toluenethiol, and the like. Alkylmercaptans are desirable among those, specifically, n-octylmercaptan, n-laurylmercaptan, and tert-dodecylmercaptan. Further, the hydrogen atom in the C—H bond may be substituted by the heavy hydrogen atom and fluorine atom in the chain transfer agent. Note that the compounds are not restricted in the above substances. Plural compounds of the chain transfer agents may be used simultaneously.

Amounts of the above-described polymerization initiators, chain transfer agents and dopants can be determined suitably according to a compound with a polymerizable characteristic. However, usually, the content of the polymerization initiators is preferably 0.005-0.050 wt. % to the polymerizable monomers for the core, and desirably 0.010-0.020 wt. %. The content of the chain transfer agent is preferably 0.10-0.40 wt. % to the polymerizable monomers for the core, and desirably 0.15-0.30 wt. %.

Also, additives can be mixed to materials for any one of the composite core 20 and the outer cladding 21 in a range not lowering the optical transmitting performance. An additive for the composite core 20 or its portion may be a stabilizer for the purpose of raising weather resistance and durability. Also, an additive may be a functional compound for induction and emission in amplifying an optical signal for the purpose of raising the optical transmitting performance. Owing to the additives, it is possible to amplify attenuated signal light by means of excitation light. A distance of transmittance can be raised, so that the optical fiber can be used as a fiber amplifier in a portion of an optical transmitting link. It is possible for the composite core 20 or the outer cladding 21 to include such additives by mixing such with the polymerizable compounds as raw material and by polymerization of those together.

Dopants are mixed to one or more of plural polymers for forming the composite core 20. Preferable examples of dopants are non-polymerizable compounds. To mix a dopant with only material for the first core 22, an amount of the dopant is preferably equal to or more than 0.01 wt. % and equal to or less than 25 wt. % relative to the polymer for the first core 22, and desirably equal to or more than 1 wt. % and equal to or less than 20 wt. %. Coefficients of the distribution of refraction can be controlled easily owing to those ranged in the radial direction of the cross section of the composite core 20. Note that densities of the dopant are determined with an increase toward the center of the radial direction.

In the embodiment, the dopants are compounds having a low molecular weight, a high refractive index, a large volume of a molecule, not reacting in a polymerizable state, and having a predetermined speed of diffusion in a molten resin. Addition of such dopants changes a refractive index of the composite core 20 in the radial direction. Dopants may be dimers, trimers or other oligomers in addition to monomers. Oligomers, of which portions of monomers have been polymerizable by reaction on the outer cladding 21 or monomer for the outer cladding 21, but which are not polymerizable in the oligomer state, can be used as dopants.

Examples of dopants include benzyl benzoate (BEN), diphenyl sulfide (DPS), triphenyl phosphate (TPP), benzyl n-butyl phthalate (BBP), diphenyl phthalate (DPP), diphenyl (DP), diphenylmethane (DPM), tricresyl phosphate (TCP), and diphenylsulfoxide (DPSO). In particular, benzyl benzoate (BEN), diphenyl sulfide (DPS), triphenyl phosphate (TPP), and diphenylsulfoxide (DPSO) are specifically preferable. A refractive index of the plastic optical fiber (POF) 11 can be changed and set as desired, determining a distribution and density of the dopant.

Among materials for producing the cores and cladding, let a first raw material be used to form the first core 22. A second raw material is used to form the second core 23. A third raw material is used to form the inner cladding 24. A fourth raw material is used to form the outer cladding 21. A dopant is mixed in any one of the raw materials for the composite core 20. Among the first, second and third raw materials, the first raw material contains dopant at a highest amount. The third raw material contains dopant at a lowest amount. Polymers in the first, second and third raw materials may be in a form of pellets or powder, but can be preferably subjected to drying process before delivery to the melt extruding process 12. This is effective in preventing occurrence of bubbles or crack in the multi-layer resin.

Also, the polymerization process for producing the polymers can be consecutive with the melt extruding process 12. The polymers in a polymerized melted state can be supplied to the melt extruding process 12. Dopants for use with those can be added to melted polymers in a suitable step, for example during a flow to the melt extruding process 12, or in a kneading component in the extruding apparatus (not shown) for melt extrusion.

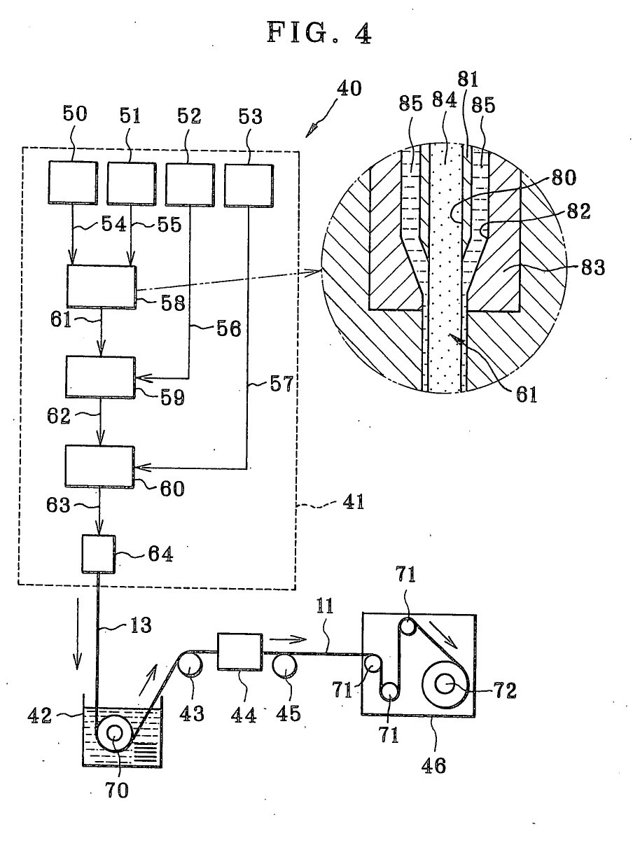

In FIG. 4, a plastic optical fiber (POF) producing apparatus or line 40 as a system is schematically illustrated. Production of the plastic optical fiber (POF) 11 in the invention is not limited to the construction of FIG. 4. The plastic optical fiber producing apparatus 40 includes a co-extruder 41 for melt extruding and various downstream elements for drawing and winding. Among those, a cooling device 42 cools the optical fiber preform 13 supplied by the co-extruder 41. A low speed godet roll 43 for drawing is adjustable for its tension applied to the optical fiber preform 13, and rotates for transporting the optical fiber preform 13 being cooled. A furnace or heater 44 applies heat to the optical fiber preform 13. A high speed godet roll 45 for drawing is adjustable for its tension applied to the optical fiber preform 13, and rotates for transporting the optical fiber preform 13 from the furnace 44. A winder 46 winds the optical fiber preform 13 finally.

The co-extruder 41 includes resin delivery sources or extruders 50, 51, 52 and 53, distribution cylinders 54, 55, 56 and 57, converging or collection blocks 58, 59 and 60 with crosshead dies, diffusion tubes 61, 62 and 63, and an extruding die 64. The extruders 50-53 deliver molten resins of the four raw materials. The distribution cylinders 54-57 are connected with the extruders 50-53, are supplied with the molten resins, for shaping the composite core 20 and the outer cladding 21. The collection blocks 58-60 are elements at suitable points between the distribution cylinders 54-57 for the purpose of a multi layer fiber having the multi layer structure in a concentric form. The diffusion tubes 61-63 cast the multi layer resin from the collection blocks 58-60 with heat, to diffuse the dopant. The extruding die 64 is supplied with the multi layer resin of the layered structure, and extrudes the optical fiber preform 13 by use of the same.

A temperature adjuster (not shown) is associated with each of the extruders 50-53, and adjusts internal temperature of the extruders 50-53 to melt raw material stored in the extruders 50-53. The converging or collection blocks 58-60 can be any suitable form according to known techniques for the purpose of forming multi layer fluid resins of a fibrous shape in which layers are overlaid on one another in a concentric form. The collection blocks 58-60 are supplied with molten resins by the distribution cylinders 54-57 and their dies to obtain layered structure. For example, the collection block 58 includes a first die element 81 and a second die element 83. A first core-forming extruding nozzle 80 is formed in the first die element 81. A second core-forming extruding nozzle 82 is formed in the second die element 83. The first extruding nozzle 80 is connected with the extruder 50, and is supplied with a first molten resin 84. The second extruding nozzle 82 is connected with the extruder 51, and is supplied with a second molten resin 85. See also FIG. 4. The extruding nozzles 80 and 82 extend to meet together at a point near to a die end of the first die element 81 contacting the second die element 83. The collection block 58 with the extruding nozzles 80 and 82 forms the first multi layer fluid resin by wrapping the first molten resin 84 with the second molten resin 85 for the first core 22. See FIG. 2.

In the collection block 59, the cladding distribution cylinder 56 extends to cover the first multi layer fluid resin. The cladding distribution cylinder 56 is connected with the extruder 52, and is supplied with the third molten resin. The collection block 59 forms the third multi layer fluid resin by wrapping the first multi layer fluid resin with the third molten resin for the inner cladding 24.

In the collection block 60, the cladding distribution cylinder 57 extends to cover the second multi layer fluid resin. The cladding distribution cylinder 57 is connected with the extruder 53, and is supplied with the fourth molten resin. The collection block 60 forms the third multi layer fluid resin by wrapping the second multi layer fluid resin with the fourth molten resin for the outer cladding 21. See FIG. 2.

The converging or collection blocks 58-60 are connected together by the diffusion tubes 61-63, which pass fluid resins from the collection blocks 58-60. Each of the diffusion tubes 61-63 is incorporated in a die which constitutes the collection blocks 58-60. The diffusion tube 61 is connected with the second die element 83. A temperature controller (not shown) is connected to an outside of the die body having the diffusion tube, and includes plural heaters. Heat can be applied by the temperature controller to the diffusion tube. Application of heat encourages diffusion of dopants, so the optical fiber preform 13 can have a change in the reflection index in the radial direction in FIG. 3. The diffusion tube 62 is provided in a third die, where the cladding distribution cylinder 56 extends to the collection block 59. The diffusion tube 63 is provided in a fourth die, where the cladding distribution cylinder 57 extends to the collection block 60. As temperature control units are associated with the third and fourth dies, heat quickens diffusion of dopants in the second and third multi layer fluid resins. Note that thicknesses of fluid resins for the composite core 20 and the outer cladding 21 in the respective distribution blocks can be equal to or less than such a thickness that temperature and residence time are low or small enough to prevent degradation of the polymers in the diffusion tubes.

Let L1, L2 and L3 be lengths of respectively the diffusion tubes 61, 62 and 63. It is preferable that any one of the lengths L1-L3 is equal to or more than 30 mm and less than 330 mm. The lengths L1-L3 may be specifically equal to or more than 100 mm and equal to or less than 300 mm, and can be desirably equal to or more than 150 mm and equal to or less than 280 mm. Should the tubes be longer than 330 mm, time required for heating the multi layer fluid resin will be considerably long. Problems will arise in degradation of polymers, and a huge space for installing equipment for the purpose of the long heating. Should the tubes be shorter than 30 mm, diffusion of the dopants will be insufficient due to the shortage in the size.

In the co-extruder 41, the converging or collection block 58 overlays first and second molten resins with different density of dopants in a coaxial form, to obtain a first multi layer fluid resin. The first multi layer fluid resin is passed through the diffusion tube 61 for diffusion of the dopants. This is a first collecting/diffusing process. After this, the collection block 59 overlays third molten resin on the first multi layer fluid resin with different density of dopants in a coaxial form, to obtain a second multi layer fluid resin. The second multi layer fluid resin is passed through the diffusion tubes 62, 63 for diffusion of the dopants. This is a second collecting/diffusing process. The number of times of the second collecting/diffusing process is at least one, and preferably at least two, and desirably three or more. The number of the plural times is not limited in particular. However, five (5) or more times of the second collecting/diffusing process is not preferable because of extremely high manufacturing cost for the structural complexity. According to the invention, diffusion of dopants in the molten resins can be made sufficiently owing to the repetition of collection and diffusion in the coaxial multi layer structure of the optical fiber preform 13.

The third multi layer fluid resin is extruded as the optical fiber preform 13 by the extruding die 64, and transported to the cooling device 42. A preferable example of the cooling device 42 is one for continuously cooling the optical fiber preform 13 transported continuously, such as a water reservoir because of a simple structure and sufficient performance for cooling. However, various examples of the cooling device 42 are usable. A cooling pipe may be provided with a jacket loaded with coolant or refrigerant to pass. The optical fiber preform 13 is passed through the cooling pipe and can be cooled. Alternatively, a fan or blower can be used to cool the optical fiber preform 13 by blowing chill gas there. Note that a guide pulley 70 is used in the embodiment, and has a shifting mechanism, for fine adjustment of the tension applied to the optical fiber preform 13 in the melt extrusion. However, a relative position of the guide pulley 70 with the water reservoir is not limited in the invention. An alternative roll may be used in place of the guide pulley 70 for the optical fiber preform 13. Also, a first outer diameter measuring device may be disposed downstream from the cooling device 42, for measuring an outer diameter of the optical fiber preform 13 moved in a non-contact manner and continuously. Various available measuring devices may be used for the diameter measuring device. It follows that the plastic optical fiber (POF) 11 having a fiber diameter can be produced rapidly and efficiently by means of diameter measurement of the optical fiber preform 13 in a continuous manner.

The optical fiber preform 13 being cooled is sent downstream from the cooling device 42 by the low speed godet roll 43, and transported to the furnace or heater 44. Heating elements (not shown) are disposed in the furnace 44 for heating the optical fiber preform 13 in the fiber traveling direction. Temperature is changed in the fiber traveling direction in applying heat to the optical fiber preform 13. Thus, diffusion of the dopants in the optical fiber preform 13 can be promoted by heating the optical fiber preform 13. However, the heating of the optical fiber preform 13 in the invention is not limited to a heater or blowing hot gas. For example, radiation heating structures of an infrared (IR) or near infrared rays may be used instead of the furnace 44. Also, tension is applied to the optical fiber preform 13 in the course of heating. Thus, the optical fiber preform 13 is heated and drawn to produce the plastic optical fiber 11. Tension applied to the optical fiber preform 13 is adjusted by changing a driving speed of the low speed godet roll 43 or the high speed godet roll 45, or the winder 46.

A cooling device cools the plastic optical fiber (POF) 11 after heating of the furnace or heater 44. This is either before or after wrapping of the plastic optical fiber 11 about the high speed godet roll 45. An example of the cooling device includes first and second gas ducts between which the plastic optical fiber 11 is located. The first gas duct blows gas to the drawn portion of the plastic optical fiber 11 when the second duct sucks the gas. This is effective in efficient cooling of the plastic optical fiber 11, and shortening a length of the manufacturing line. Note that a blowing duct may be disposed not downstream from the furnace 44. The blowing duct may be disposed inside the furnace 44 and downstream from a heater (not shown). Of course, various known cooling methods can be used by suitable modifications in the present invention. For example, a melted portion can be transported through a pipe having a jacket where a coolant or refrigerant flows through.

The plastic optical fiber (POF) 11 after the cooling is wound by the winder 46 while tension applied to the plastic optical fiber 11 is controlled. A plurality of guide pulleys 71 are incorporated in the winder 46, and support and transport the plastic optical fiber 11. A winding roll 72 in the winder 46 winds the plastic optical fiber 11. Note that a thermostat chamber (not shown) can be used to apply heat to the plastic optical fiber 11 for a predetermined time after winding about the winding roll 72. This is preferable because the diffusion of the dopants in the plastic optical fiber 11 can be sufficient. In the above embodiment, the drawing process in the plastic optical fiber producing apparatus 40 is directly next to the extruding process to obtain the optical fiber preform 13. However, the present invention is not limited to this method. It is possible to wind the optical fiber preform 13 about a bobbin in a state of a self-supporting property, and to unwind and heat the optical fiber preform 13 from the bobbin to create the plastic optical fiber 11 by drawing.

The plastic optical fiber (POF) 11 of the invention includes at least one protective layer overlaid as a coat for various purposes, which include higher bendability, higher resistance to climate, suppression of drop in performance due to absorption of moisture, higher tensile strength, resistance to deformation due to treading, flame retardant property, chemical resistance, protection from signal noise due to ambient light, and coloring for appearance as merchandise.

Note that the plastic optical cable 17 can be constructed by applying a coating to a bundle of a plurality of the plastic optical fiber (POF) 11, unlike the above example of the plastic optical cable 17 obtained by coating a single cord of the plastic optical fiber 11. In other words, two coating manners exist, including a tight fitted type of coating and a loose covering type of coating. In the tight fitted type, the plastic optical fiber 11 is covered by the coating tightly without a void in the entire interface between those. In the loose covering type, the plastic optical fiber 11 is covered by the coating loosely with numerous minute voids. If a protective layer in the loose covering type is peeled from a portion for connection, water is likely to penetrate in the minute voids uncovered at the end face, and to diffuse in the fiber longitudinal direction. Therefore, it is preferable normally to construct the tight fitted type of coating in comparison with the loose covering type.

However, in the loose covering type, as the cable coating is not adhered to the entire surface of the plastic optical fiber (POF) 11, the influences of the stress or heat on the plastic optical cable 17 becomes smaller. Accordingly, the damage of the plastic optical fiber 11 is reduced. The loose covering type is preferred for a certain purpose. In order to prevent the penetration of the moisture, the void between the cable coating and the optical fiber bundle is filled with mills or gel-like semisolid materials having fluidity. Further, as the mills or semisolid materials have effects for preventing the moisture penetration, the cable coating of high quality is formed. When the cable coating of the loose covering type is formed, the position of the extrusion opening of the crosshead dies is adjusted, and the decompressing device for forming the void is adjusted. The thickness of the void can be controlled effectively and precisely for a very thin form.

It is possible for the plastic optical fiber (POF) 11 to have a second protective layer as required about the first protective layer described above. If the first protective layer has a sufficient thickness, thermal damage can be reduced by the first protective layer. Raw materials for the first protective layer can be determined with relatively unlimited hardening temperature in comparison with the use of only the first protective layer. Additives may be mixed with the material for the second protective layer, such as flame retardants, ultraviolet (UV) absorbers, antioxidants, radical scavengers, lubricants and the like, in the same manner as that for the coating materials.

A coating material is preferably a thermoplastic resin. The coating material should be a material which will not thermally damage the plastic optical fiber 11, for example deformation, thermal modification or thermal decomposition. A preferable example of thermoplastic resin is characteristically hardenable at a temperature equal to or lower than the glass transition temperature Tg deg. C. of the plastic optical fiber 11 and at a temperature equal to or higher than (Tg-50) deg. C. In view of reducing the manufacturing cost, molding time of the thermoplastic resin, namely time required to harden the thermoplastic resin, can be preferably equal to or more than 1 second and equal to or less than 10 minutes, and equal to or more than 1 second and equal to or less than 5 minutes. Note that, when plural polymers are used to form the plastic optical fiber 11, a lowest value among the glass transition temperatures of the polymers is determined as the glass transition temperature Tg (deg. C.) of the plastic optical fiber 11. If the polymers in the plastic optical fiber 11 do not have a glass transition temperature, then temperature of a change between phases, for example a melting point, is used in place of the glass transition temperature Tg (deg. C.) of the plastic optical fiber 11.

Examples of thermoplastic resins include polyethylene (PE), polypropylene (PP), vinyl chloride (PVC), copolymer of ethylene/vinyl acetate (EVA), copolymer of ethylene/ethyl acrylate (EEA), polyester, and nylon. Also, various elastomers may be used as coating materials. The use of elastomers makes it possible to impart flexing or other mechanical characteristics owing to high elasticity. Examples of elastomers include rubbers, such as rubbers of isoprene compounds, rubbers of butadiene compounds, special rubbers of diene compounds. Also, elastomers can be fluid rubbers of polydiene compounds or polyolefin compounds, which are fluid at the room temperature, but thermoset to lose fluidity when heated, and can be thermoplastic elastomers (TPE) which are elastic and rubber-like at the room temperature, but fluidized to facilitate molding when heated. Also, a fluid composition obtained by mixing a polymer precursor and reacting agent and having a thermoset property can be used. An example of this is disclosed in U.S. Pat. No. 5,866,668 (corresponding to WO 95/26374) as thermoset urethane composition of one liquid type (without hardening agent) containing urethane prepolymer and solid amine with a diameter of 20 microns or less, the urethane prepolymer containing an NCO group.

A coating material for the plastic optical fiber (POF) 11 is not limited in particular if moldable at a temperature equal to or lower than the glass transition temperature Tg of the polymers used in the plastic optical fiber 11. Other examples include copolymers obtained polymerizing two or more of the above or other compounds, and blends of at least one of the above or other compounds and at least one of the copolymers. Various fillers can be also used for additional characteristics, and can contain inorganic compounds, organic compounds, and such additives as flame retardants, ultraviolet (UV) absorbers, antioxidants, radical scavengers, lubricants and the like.

Also, coatings of other functional characteristic layers may be applied outside the plastic optical cable 17. Examples of such functional characteristic layers include the flame retardant layer above, a barrier layer for reducing absorption of moist in the plastic optical fiber (POF) 11, and a moist absorbing layer for eliminating moist from the plastic optical fiber 11. Various methods for applying those coatings may be used, including positioning a moist absorbing tape or moist absorbing gel within or between the coating layers or sheath layers. Examples of such functional characteristic layers include a soft material layer for lowering stress upon being flexed, a foaming material layer for cushioning in response to receiving external stress, and a reinforcing layer for raising rigidity. The coating or sheath of the plastic optical cable 17 may be produced from substances different from resins, for example, a composite element having a base of thermoplastic resin and a fibrous material contained in the base, the fibrous material being at least one of high tensile-strength wire or filament having high elasticity, and wire of metal with high rigidity. The use of such a composite element is effective in reinforcement of mechanical strength of the plastic optical cable 17 as a final product.

Examples of the high tensile strength wire include aramid fiber, polyester fiber, polyamide fiber and the like. Examples of the metallic fiber include stainless fiber, zinc alloy fiber, copper fiber and the like. However, the substances of these fibers in the invention are not restricted in them. Further, in order to prevent the damage of the plastic optical cable 17, metallic pipes may be provided around the optical materials, such as the optical fiber bundle or the optical fiber cable, or the like. A support line may be provided along them, and otherwise a machine or a mechanism may be used for increasing the workability in connecting the optical materials. Further, in accordance with the way of use, the plastic optical cable 17 is selectively used in a cable assembly in which the plastic optical cable 17 is concentrically arranged, a tape fiber cord in which the plastic optical cable 17 is linearly aligned, and a cable assembly in which the tape fiber cords are bundled with a band, a wrap sheath or the like.

Further, the plastic optical cable 17 of the present invention may be interconnected by the matching or abutment, since having higher axial offset tolerance than the prior optical fiber. However, it is preferable that an optical connector is provided at an end of optical fibers for connection by fixing. Examples of connectors usually known include PN type, SMA type, SMI type, and the like. There are several systems for transmitting the optical signals available for use with the plastic optical cable 17 of the present invention. The system is constructed of an optical signal processing device which includes the plastic optical cable 17 and parts, such as a light emitting element, a light receiving element, an optical switch, an optical isolator, an optical integrated circuit, an optical transmission/reception module, and the like. Further, another type of the optical fiber and the like may be used in the system, if necessary. In this case, any known techniques can be applied to the present invention. The techniques are described in such documents as ‘Plastic Optical Fiber No Kiso To Jissai’ (Basic and Practice of Plastic Optical Fiber) issued by NTS Inc., and ‘Print Haisen Kiban Ni Hikari Buhin Ga Noru, Ima Koso’ (Optical Parts can be Loaded on Printed Wiring Assembly, at Last) in Nikkei Electronics, 3 Dec. 2001, pages 110-127, issued by Nikkei Business Publications, Inc., and so on. When the present invention is combined with the techniques in these publications, then the plastic optical cable 17 can be used for the wiring in apparatuses (such as computers and several digital apparatuses), the wiring in the vehicles and vessels, the linking between optical terminals and the digital device, and between the digital devices. Further, in the combination of the invention with the above techniques, the plastic optical cable 17 may be applied to the optical transmitting system adequate for optical transmission in short distance, for example, for data communication of large capacity, for use of control without influence of the electromagnetic wave. Specifically, the plastic optical cable 17 produced in the invention can be applied to the optical LAN in each of or the optical LAN between houses, apartment houses, factories, offices, hospitals, schools in an area, or the optical LAN in each of them.

Further, the other techniques to be combined are disclosed in documents. Examples of the documents are:

‘High-Uniformity Star Coupler Using Diffused Light Transmission’ in IEICE TRANS. ELECTRON., Vol. E84-C, No. 3, March 2001, p. 339-344, and

Hikari Sheet Bus Gijutsu Ni Yoru Interconnection (Interconnection in Technique of Optical Sheet Bus) in Journal of Japan Institute of Electronics Packaging, Vol. 3, No. 6, 2000, p. 476-480.

Various further techniques include:

disposition of a light-emitting element relative to a waveguide surface (disclosed in U.S. Pat. No. 6,814,501 (corresponding to JP-A 2003-152284) and the like)

a light bus (disclosed in disclosed in U.S. Pat. No. 5,822,475 (corresponding to JP-A 10-123350), JP-A 2002-090571, JP-A 2001-290055 and the like)

an optical branching/coupling device (disclosed in JP-A 2001-074971, JP-A 2000-329962, JP-A 2001-074966, JP-A 2001-074968, JP-A 2001-318263, JP-A 2001-311840 and the like)

an optical star coupler (disclosed in JP-A 2000-241655)

a device for optical signal transmission and a light data bus system (disclosed in U.S. Pat. No. 6,792,213 (corresponding to JP-A 2002-062457), JP-A 2002-101044, JP-A 2001-305395 and the like)

a processing device of optical signal (disclosed in JP-A 2000-023011 and the like)

a cross connect system for optical signals (disclosed in JP-A 2001-086537 and the like)

a light transmitting system (disclosed in JP-A 2002-026815 and the like)

a multi-function system (disclosed in JP-A 2001-339554, U.S. Pub. No. 2002/0093677 (corresponding to JP-A 2001-339555), and the like).

In addition, various types of waveguides, optical branching, optical couplers, optical multiplexers, optical demultiplexers and the like, may be used. As the present invention is combined with these techniques, the optical elements are used in a system of the optical transmission of high grade, in which the signal is sent and received, and otherwise used for lighting, energy transmission, illumination, and sensors.

It is to be noted regarding the principal features of the invention that various known techniques in relation to distributors and collectors for flows of resins may be used in combination. Examples of various techniques for such are disclosed in U.S. Pat. No. 4,832,589, U.S. Pat. No. 5,641,445 (corresponding to JP-A 2001-517158), and U.S. Pat. No. 5,672,303 (corresponding to JP-A 7-504861).

Examples of the invention are hereinafter described. Note that the invention is not limited to those specific examples.

### EXAMPLE 1

The plastic optical fiber producing apparatus 40 of FIG. 4 was used to create the plastic optical fiber (POF) 11 according to the process in FIG. 1. The co-extruder 41 included four screw extruders with a screw diameter of 16 mm, three converging or collection blocks, and three diffusion tubes. The first molten resin for the first core 22 was 100 wt. % of a blend of polymethyl methacrylate (PMMA) and 20% of diphenyl sulfide (DPS). The second molten resin for the second core 23 was 100 wt. % of a blend of PMMA and 10% of DPS. The third molten resin for the inner cladding 24 was 100 wt. % of PMMA. The fourth molten resin for the outer cladding 21 was 100 wt. % of polyvinylidene fluoride (PVDF). For the extrusion from the four extruders to the distributors, extruding temperature to form the composite core 20 was 210 deg. C., and extruding temperature to form the outer cladding 21 was 230 deg. C. The diffusion tubes 61-63 had an inner diameter of 20 mm, had a length of 30 cm, and were conditioned at an inner temperature of 190 deg. C. Any one of the diffusion tubes had a length L of 300 mm. The collection and diffusion were conducted at three times successively, to form a four-layer fluid resin, which was extruded through the extruding die 64 with an inner diameter of 1 mm. Thus, the optical fiber preform 13 was formed.

A water reservoir was used as the cooling device 42, to cool the optical fiber preform 13. After this, the low speed godet roll 43 drew the optical fiber preform 13 at a speed of 5 meters per minute. The furnace or heater 44 was an oven, which was conditioned at 150 deg. C. to heat the optical fiber preform 13. During application of heat, the high speed godet roll 45 drew the optical fiber preform 13 at a speed of 9 meters per minute. The optical fiber preform 13 was stretched to have a diameter of 750 microns. After this, the optical fiber preform 13 was wound by the winder 46 to produce the plastic optical fiber (POF) 11. A period of extrusion for producing the plastic optical fiber 11 was one (1) hour.

### [Comparison 1]

Example 1 was repeated in producing the plastic optical fiber 11 in relation to the raw materials and any condition of production, except for the diffusion tubes. The co-extruder 41 had the diffusion tubes of which the length L was 25 mm.

### [Comparison 2]

Example 1 was repeated in producing the plastic optical fiber 11 in relation to the raw materials and any condition of production, except for the diffusion tubes. The co-extruder 41 had the diffusion tubes of which the length L was 1,000 mm.

### [Comparison 3]

The plastic optical fiber 11 was produced according to the flow of FIG. 1. The use of the co-extruder 41 in FIG. 4 was repeated with a difference in the use of a converging or collection block in passages from the five screw extruders with a screw diameter of 16 mm were joined at one point. The collection and diffusion were conducted at one time to create the optical fiber preform 13 and then the plastic optical fiber 11. In relation to producing the plastic optical fiber 11 in the raw materials and any condition of production and the size of the diffusion tubes, Example 1 was repeated.

### [Comparison 4]

The plastic optical fiber 11 was produced according to the flow of FIG. 1. The use of the co-extruder 41 in FIG. 4 was repeated, but with a difference in that the composite core 20 had only a two-layer structure with the first and second cores. The plastic optical fiber 11 inclusive of the outer cladding 21 had a three-layer structure. To produce the plastic optical fiber 11, the number of times of the collection and diffusion was two (2). For the first core in the composite core 20, 100 parts by weight of PMMA and DPS was used for forming. For the second core in the composite core 20, 100 parts by weight of only PMMA was used for forming. 20% of DPS was included in the material of the first core. Also, for the outer cladding 21, 100 parts by weight of PVDF was used for forming. The use of the diffusion tubes of Example 1 was repeated.

### [Method of evaluation]

The plastic optical fiber (POF) 11 was left to stand for one (1) hour after the production, and then cut into sample strips of 30 meters. 10 sample strips were prepared, and subjected for measurement of attenuation (dB) of transmission by a cutback method. After the measurement of 10 times, average attenuation was calculated, and was compared with a unit attenuation in the transmission per one km. A grade A of being good was given by evaluation when the attenuation in the transmission was 200 dB/km or less. In the same evaluation, a grade B of being passable and a grade F of being failure were given. Also, a bandwidth of the plastic optical fiber 11 was measured, to evaluate acceptability of distribution of refraction.

In Table 1, results of the observation of Example 1 and Comparisons 1-4 are indicated. In the table, A denotes good, B denotes passable, and F denotes failing.

TABLE 1

| | Exam- | Compari- | Compari- | Compari- | Compari- |
|---|---|---|---|---|---|
| | ple 1 | son 1 | son 2 | son 3 | son 4 |
| No. of times | 3 | 3 | 3 | 1 | 2 |
| of | | | | | |
| collecting/ | | | | | |
| diffusing | | | | | |
| process | | | | | |
| Length L (mm) | 330 | 25 | 1,000 | 330 | 330 |
| of diffusion | | | | | |
| tube | | | | | |
| Average | 160 | 160 | 190 | 200 | 160 |
| attenuation | | | | | |
| (dB/km) in | | | | | |
| transmission | | | | | |
| Evaluation | A | A | B | B | B |
| for use | | | | | |

A result of Example 1 is clarified in Table 1. The diffusion tubes were L=300 mm long. The plastic optical fiber (POF) 11 was produced after three times of the collecting/diffusing process. As a result, an average attenuation in the transmission was 160 dB/km, and was graded as A or acceptable in a practical use. The bandwidth was 2.0 Gbps, and could have a sufficiently large distribution of a refractive index of the plastic optical fiber 11.

According to Comparison 1, the diffusion tubes were L=25 mm long. The plastic optical fiber 11 was produced after three times of the collecting/diffusing process. As a result, an average attenuation in the transmission was 160 dB/km, and was graded as A or acceptable in a practical use. However, the bandwidth was 0.5 Gbps, and did not result in a sufficiently large distribution of a refractive index of the plastic optical fiber 11.

According to Comparison 2, the diffusion tubes were L=1,000 mm long. The plastic optical fiber 11 was produced after three times of the collecting/diffusing process. As a result, an average attenuation in the transmission was 190 dB/km. In two included in 10 samples of Comparison 2, an average attenuation in the transmission was 200 dB/km or higher. In conclusion, an average attenuation in the transmission was graded as B or passable in a practical use. The bandwidth was 2.0 Gbps, and could have a sufficiently large distribution of a refractive index of the plastic optical fiber 11. A problem lied in a visually recognizable yellow stain in the plastic optical fiber 11. It is supposed that the polymer became degraded due to the diffusion tubes as long as 1,000 mm, and longer time of heating.

According to Comparison 3, the structure of the diffusion tubes of Example 1 was repeated. However, all of the raw materials were co-extruded at one time to obtain the plastic optical fiber 11 with a multi layer structure. As a result, an average attenuation in the transmission was 200 dB/km, and was graded as B or passable in a practical use. However, the bandwidth was 0.5 Gbps, and did not result in a sufficiently large distribution of a refractive index of the plastic optical fiber 11.

According to Comparison 4, the structure of the diffusion tubes of Example 1 was repeated. The plastic optical fiber 11 was produced after three times of the collecting/diffusing process. As a result, an average attenuation in the transmission was 160 dB/km, and was graded as A or acceptable in a practical use. However, the bandwidth was 0.5 Gbps, and did not result in a sufficiently large distribution of a refractive index of the plastic optical fiber 11.

It is concluded that the plastic optical fiber (POF) 11 with high performance can be produced with a large bandwidth and low attenuation in the transmission owing to the production in which the collection and diffusion is repeated for two or more times successively, the diffusion tubes for diffusing dopants have the length L equal to or more than 30 mm and equal to or less than 330 mm. A particularly preferable number of the times of the collecting/diffusing process is found three.

### INDUSTRIAL APPLICABILITY

It is possible to produce the plastic optical fiber (POF) 11 having intended distribution of refractive indexes, because the polymers can be prevented from thermal degradation, and dopants can be diffused sufficiently by the plural times of the collecting/diffusing process to treat the multi layer fluid resin.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A producing method of producing a plastic optical fiber in which a refractive index is distributed in a direction toward a center of a diameter, comprising:
a first collecting/diffusing step of causing first and second molten resins together to flow to form a first multi layer fluid resin in a concentric fiber shape, and of diffusing a dopant in said first multi layer fluid resin by a first diffuser, said first and second resins containing said dopant at densities different from one another; and
at least one second collecting/diffusing step of causing a third molten resin to flow together with said first multi layer fluid resin to form a second multi layer fluid resin in a concentric fiber shape, and of diffusing said dopant in said second multi layer fluid resin by a second diffuser, said second and third resins containing said dopant at densities different from one another, whereby said plastic optical fiber is produced from at least said first, second and third resins.

2. A producing method as defined in claim 1, further comprising:
an extruding step of extruding said second multi layer fluid resin to produce an optical fiber preform; and
a drawing step of thermally drawing said optical fiber preform, to form said plastic optical fiber.

3. A producing method as defined in claim 2, wherein in said first collecting/diffusing step, said second resin being molten is distributed to flow in a ring shape, together to flow said first and second resins by delivering said second resin about said first resin while said first resin being molten flows in a rod shape;
in said second collecting/diffusing step, said third resin being molten is distributed to flow in a ring shape, together to flow said first multi layer fluid resin and said third resin by delivering said third resin about said first multi layer fluid resin.

4. A producing method as defined in claim 2, further comprising a cooling step of cooling said optical fiber preform from said extruding step, wherein said drawing step is provided with said optical fiber preform by said cooling step.

5. A producing method as defined in claim 2, wherein said first and second diffusers have a size L in a direction of a flow of said first or second multi layer fluid resin, and said size L is equal to or more than 30 mm and equal to or less than 330 mm.

6. A producing method as defined in claim 5, wherein said at least one second collecting/diffusing step is at least two second collecting/diffusing steps.

7. A producing method as defined in claim 6, wherein said densities of said dopant in said first, second and third resins are higher according to closeness of said first, second and third resins to said center.

8. A producing method as defined in claim 7, wherein said first, second and third resins contain a polymer created from a (meth)acrylate ester.

9. A producing apparatus for producing a plastic optical fiber in which a refractive index is distributed in a direction toward a center of a diameter, comprising:
a first collector for causing first and second molten resins together to flow to form a first multi layer fluid resin in a concentric fiber shape; and
at least one second collector for causing a third molten resin to flow together with said first multi layer fluid resin to form a second multi layer fluid resin in a concentric fiber shape, so as to produce said plastic optical fiber from at least said first, second and third resins.

10. A producing apparatus as defined in claim 9, further comprising:
a first distributor for distributing said second resin being molten to flow in a ring shape, together to flow said first and second resins by delivering said second resin about said first resin being molten supplied in said first collector;
at least one second distributor for distributing said third resin being molten to flow in a ring shape, together to flow said first multi layer fluid resin and said third resin by delivering said third resin about said first multi layer fluid resin being molten supplied in said at least one second collector.

11. A producing apparatus as defined in claim 10, wherein said first, second and third resins contain a dopant at densities different from one another;
further comprising:
a first diffuser for diffusing said dopant in said first multi layer fluid resin; and
a second diffuser for diffusing said dopant in said second multi layer fluid resin.

12. A producing apparatus as defined in claim 11, wherein said at least one second collector is at least two second collectors consecutive with one another.

13. A producing apparatus as defined in claim 12, further comprising:
an extruding die for extruding said second multi layer fluid resin to produce an optical fiber preform; and
a drawing device for thermally drawing said optical fiber preform, to form said plastic optical fiber.

14. A producing apparatus as defined in claim 13, further comprising a cooling device, positioned downstream from said second collector, for cooling said optical fiber preform.

15. A producing apparatus as defined in claim 11, wherein said first and second diffusers have a size L in a direction of a flow of said first or second multi layer fluid resin, and said size L is equal to or more than 30 mm and equal to or less than 330 mm.

16. A producing apparatus as defined in claim 11, wherein said densities of said dopant in said first, second and third resins are higher according to closeness of said first, second and third resins to said center.

17. A producing apparatus as defined in claim 9, wherein said first, second and third resins contain a polymer created from a (meth)acrylate ester.
